(19) United States
(12) Patent Application Publication
(10) Pub. No.: US 2023/0368161 A1
(43) Pub. Date: Nov. 16, 2023

(54) Perpetually Stable Cryptocurrency Coinage

(71) Applicants: Philip Muller, New Hope, PA (US); Zachary Muller, New Hope, PA (US)

(72) Inventors: Philip Muller, New Hope, PA (US); Zachary Muller, New Hope, PA (US)

(21) Appl. No.: 17/743,116

(22) Filed: May 12, 2022

(51) Int. Cl. G06Q 20/06; H04L 9/00

(52) U.S. Cl. CPC G06Q 20/0655; H04L 9/50; G06Q 2220/00; H04L 2209/56

(57) ABSTRACT

An algorithmic methodology for creating a cryptographic token or coin which maintains a significantly stable value to be used on a blockchain, an algorithmic cryptographic coinage that removes market volatility and maintains stable value in perpetuity to facilitate worldwide adoption of blockchain technology.

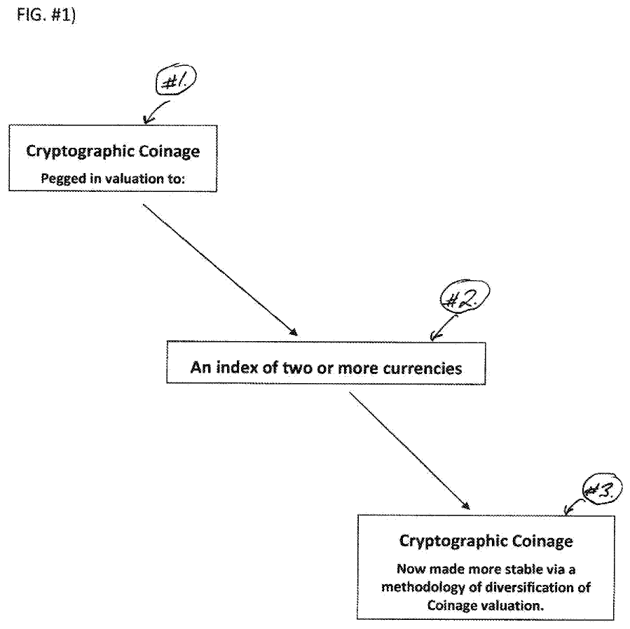

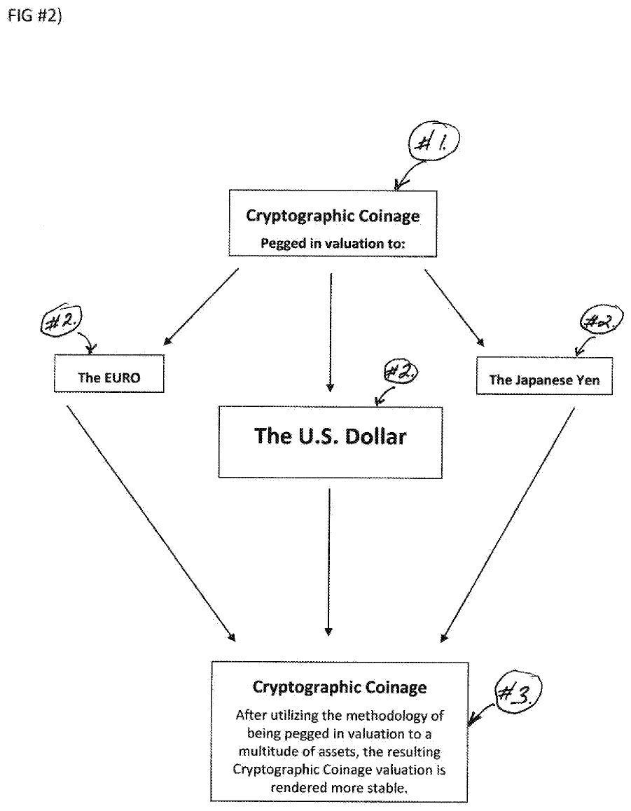

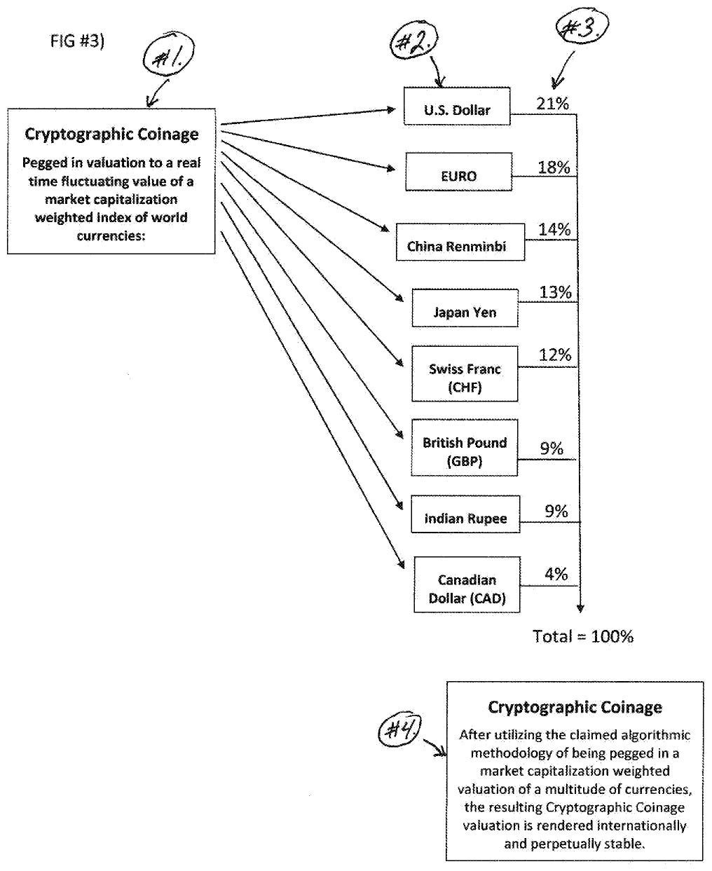

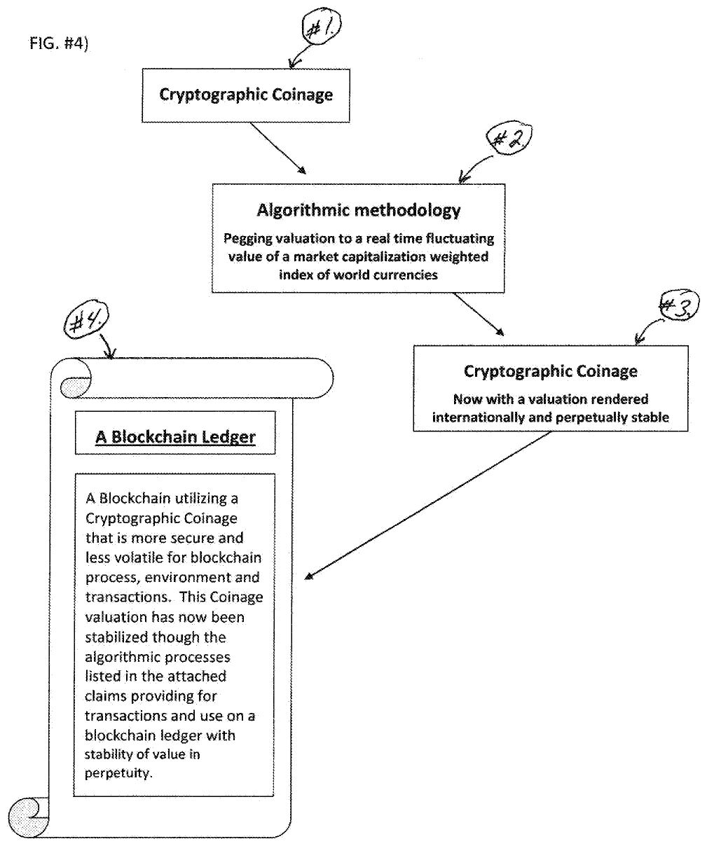

### BACKGROUND

Cryptographic coinage and blockchains are growing in usage. As usage grows however, volatility has become a problem. The markets for cryptographic coinage have become highly speculative. Stable coins, whose valuations are pegged to a perceived stable asset, are intended to help alleviate this instability however they are still vulnerable to that assets valuation volatility and lifespan. Even with the adoption of the so called stable coins, their valuations being pegged to hard assets or fiat currencies, each are still capable of extreme price variations which is hindering mainstream adoption. Since many Blockchains and Blockchain ledger technologies presents considerable value to business and society through the world wide adoption of Fin-Tec, an algorithmic methodology by which a timeless and universally accepted stabilization of Cryptographic coinage is necessary.

Bitcoins as an example, falls short of addressing the many hurtles necessary for a worldwide adoption of Cryptographic coinage. Although creating a decentralized store of value, in the example of Bitcoin and similar Cryptographic coinage, it relies solely on public adoption to give it value. That public acceptance and valuation by the masses is wildly speculative and lacks the stability for the consistent and economically stable use of blockchain in business and commerce.

So called Cryptographic Stable Coins that are based on pegging their value to a given asset or even today's world currency, the U.S. Dollar, does not address the inherent fluctuations of that given asset or Dollar, nor does it address the devaluation of currencies or the ever shifting world macroeconomics.

To solve these problems, I have created an algorithmic methodology which pegs cryptographic coinage to an indexing of multiple real-time fluctuating values of a multitude of the world currencies, thus eliminating the volatility and potential devaluation of a currency at any given time while remaining adaptable in real-time to the geo-financial fluctuations that inevitably occur over seconds, days, years and centuries.

This algorithm indexes a multitude of the premiere world currencies in a market capitalization weighted algorithmic index which varies in real-time, thus perpetually giving not just perceived stability to a given coinage, but timeless perpetual worldwide stability regardless of shifting world macroeconomics.

This algorithmic methodology, which creates a perpetually stable cryptographic coin, may be utilized in a decentralized market exchange or a centralized market exchange and or any given blockchain.

The currencies included in the index are expected to change in valuation and in their respective percentage of the index itself given each currencies own volatility and changing valuation at any given time.

Not unlike the way energy cannot be created or destroyed, it can only change forms; the total of the world's consumer spending capability is a static 100% at any given time. Its numeric value will consistently fluctuate and the geographic allocation of that spending capability will also fluctuate. However, the total consumer valuation of the world is always 100%. My Algorithm most closely matches this phenomenon and makes it possible, for the first time, for a cryptographic coinage value to remain as closely linked to the world total consumer valuation however and whenever it fluctuates creating cryptographic coinage valuation stability in perpetuity.

### BRIEF DESCRIPTION OF THE OF THE DRAWINGS

The features, aspects, and advantages of the exemplary embodiments are understood when the following Detailed Description is read with reference to the accompanying drawings, wherein:

FIG. #1) illustrates a simplified mechanism of stability for cryptographic coinage;

FIG. #2) illustrates a simplified methodology for cryptographic coinage indexing of multiple currencies;

FIG. #3) illustrates an algorithmic methodology for cryptographic coinage market cap weighted indexing, according to exemplary embodiments;

FIG. #4) illustrates the use of the algorithmic methodology for cryptographic coinage market cap weighted indexing and its adoption of use on a blockchain;

### DETAILED DESCRIPTION

The above listed exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific drawing examples thereof, are intended to encompass both structural and functional equivalents thereof. Additionally, it is intended that such equivalents include both currently known equivalents as well as equivalents developed in the future (i.e., any elements developed that perform the same function, regardless of structure or origin, including but not limited to, additional currencies).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware or software as well as hardware capable of executing associated software. Those, of ordinary skill in the art further understand that the exemplary hardware, software, processes, methods, and/or operating systems described herein are for illustrative purposes and, thus, are not intended to be limited to any particular named manufacturer of hardware or software or to be limited to centralized or decentralized blockchain and is not intended to restrict the claims to any one blockchain or currency, but rather to include all blockchains and all currencies either now in use or yet to be developed.

As used herein, the singular forms “a,” “an,” and “the” are intended to include the plural forms as well, unless expressly stated otherwise. It will be further understood that the terms “inclusion”, “distribution”, “determined”, “pegged”, “including”, “methodology”, “indexed” and/or “comprising,” when used in this application, specify the presence of stated features, integers, steps, operations, elements, and/or components, but do not preclude the presence or addition of one or more other features, integers, steps, operations, elements, components, and/or groups thereof. It will be understood that when an element is referred to as being, “indexed” or “pegged” to another element, it can be directly connected or coupled to the other element or elements in whole or as a percentage of said elements. Furthermore, “indexed”, “determined”, or “pegged”, as used herein may include any and all combinations of one or more of the associated listed items. It will also be understood that, although the terms listed above may be used herein to describe various elements and procedures, these elements and procedures should not be limited by these terms. These terms are only used to distinguish one element or procedure from another without departing from the teachings of the disclosure.

FIG. #1)

Illustrates a simplified mechanism of stability for cryptographic coinage. The first block (#1) indicates a basic cryptographic coin. The second block (#2) indicates the first block being linked to an index consisting of multiple currencies. The third block (#3) indicates the now much more stable coin.

FIG. #2)

Illustrates a simplified methodology for cryptographic coinage indexing of multiple currencies. The first block (#1) indicates a basic cryptographic coin. The three middle blocks (#2) indicates the first block being linked to an index consisting of multiple currencies. The third block (#3) indicates the now much more stable coin.

FIG. #3)

Illustrates an algorithmic methodology for cryptographic coinage market cap weighted indexing, according to exemplary embodiments. The first block (#1) indicates a basic cryptographic coin. The column of blocks to the right (#2) represent the indexing of certain currencies, (the included currencies and their allocations are for example purposes only), the percentages listed (#3) accompanying the individual currencies indicate, (for example purposes only), that each currency in the index will have allocations based on their economic standing at any given time.

The algorithm will adjust according to changes in both the economic standing and percentage of valuation as well as actual valuation of that given currency and will be calculated to derive the index value for the cryptographic coinage shown as the lower block (#4).

FIG. #4)

Illustrates the use of the algorithmic methodology for cryptographic coinage market cap weighted indexing and its adoption of use on a blockchain.

The first block (#1) indicates a basic cryptographic coin. The second block down (#2) represents the indexing of certain world currencies utilizing the real-time market cap weighted index of those currencies. The third block (#3) represents the cryptographic coinage now having been valued by the claimed algorithmic methodology, having an internationally and perpetually stable valuation to the world economy. The fourth and final graphic (#4) indicates the use of the now exemplary stable cryptographic coin in use on a blockchain ledger system.

I hereby claim as my invention:

1. An algorithmic methodology for creating cryptographic coinage having a pegged valuation to an index of multiple currencies whereby the distribution of each currencies valuation contributes to the cryptographic coinage stability of value.

2. The algorithm of claim 1, for creating cryptographic coinage having a pegged valuation to an index of multiple, currencies whereby the distribution of each currency's valuation contributes to the cryptographic coinage stability of value.

3. The algorithmic methodology of claim 1, wherein each currency's valuation in the index is predicated on its economic strength and market capitalization weighted dominance in the world at a given time.

4. The algorithmic methodology of claim 1, wherein each currency's valuation in the index fluctuates pursuant to its economic strength and market capitalization weighted dominance in the world at a given time.

5. The algorithmic methodology of claim 1, wherein the inclusion of currencies in the index fluctuates pursuant to its economic strength and market capitalization weighted dominance in the world at a given time.

6. The algorithm of claim 2, wherein each currency's valuation in the index is predicated on its economic strength and market capitalization weighted dominance in the world at a given time.

7. The algorithm of claim 2, wherein each currency's valuation in the index fluctuates pursuant to its economic strength and market capitalization weighted dominance in the world at a given time.

8. The algorithm of claim 2, wherein the inclusion of currencies in the index fluctuates pursuant to its economic strength and market capitalization weighted dominance in the world at a given time.

9. The index of claim 1, wherein each currency's valuation is predicated on its economic strength and market capitalization weighted dominance in the world at any given time.

10. The cryptographic coinage of claim 1, wherein its intending use is for trading.

11. The cryptographic coinage of Claire 1, wherein its intending use is for transactions.

12. The cryptographic coinage of claim 1, wherein its intending use is for transactions recorded on a blockchain.

13. The cryptographic coinage of claim 1, wherein its intending use is for transactions recorded on a centralized blockchain.

14. The cryptographic coinage of claim 1, wherein its intending use is for transactions recorded on a decentralized blockchain.

15. The algorithmic methodology of claim 1, wherein the cryptographic coinage intrinsic value is determined by a market capitalization weighted index of the valuation of multiple currencies.

16. The algorithm of claim 2, wherein the cryptographic coinage intrinsic value is determined by a market capitalization weighted index of the valuation of multiple currencies.

17. The algorithmic methodology of claim 1, wherein the cryptographic coinage intrinsic value is determined by a market capitalization weighted index of the valuation of multiple fiat currencies.

18. The algorithmic methodology of claim 1, wherein the algorithm creates a market capitalization weighted index of multiple currencies.

19. The algorithm of claim 2, wherein the algorithm creates a market capitalization weighted index of multiple currencies.

20. The algorithmic methodology of claim 1, wherein the cryptographic coinage intrinsic value matches the valuation of a market capitalization weighted index of the valuation of multiple world currencies.
